(19) United States
(12) Patent Application Publication
(10) Pub. No.: US 2008/0202706 A1
(43) Pub. Date: Aug. 28, 2008

(54) Device for Sealing and/or Protecting Construction Openings

(76) Inventor: Michael Fath, Bremen (DE)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 10/568,020

(22) PCT Filed: Jan. 26, 2005
(86) PCT No.: PCT/EP2005/000733

§ 371 Date: May 6, 2008

(30) Foreign Application Priority Data
Feb. 19, 2004 (DE) 10 2004 008 553.6

(51) Int. Cl. E06B 9/06

(52) U.S. Cl. 160/199

(57) ABSTRACT

A device for the closure and/or protection of openings in structures has closure elements (10), which are arranged in such a way that they hang under running carriages (12) which can be made to move in a running rail (13).

In the device according to the invention, each running carriage (12) has a bearing body (32) made of plastic, four running wheels (22) made of plastic, mounted on two parallel axes, and a sliding bearing (33) made of plastic and with good emergency running properties, assigned to each running wheel (22). This ensures that the closure elements (10) connected in a hinge-like manner are reliably folded together and unfolded.

### BACKGROUND OF THE INVENTION

1. Technical Field

The invention relates to a device for the closure and/or protection of openings in structures with vertical closure elements in strip form, which are connected to one another in a hinge-like manner and in such a way that they can be turned about vertical longitudinal central axes, and with running carriages, which can be made to move on a horizontal running rail and from which at least some closure elements are suspended.

2. Prior Art

Openings in structures of any kind, to be precise in particular those which are or can be closed by doors or windows, are often (additionally) protected by devices of the type referred to here, comprising vertical closure elements in strip form, which preferably hang together in a hinge-like manner at their neighbouring longitudinal edges and can be turned about vertical central axes. The hinge-like connection of the closure elements and the rotatability of the same about their vertical central axes makes it possible to move the device to the side when it is not in use, in a way similar to curtains, whereby the windows or doors to which the device is assigned are exposed. Only when required, in particular when leaving the building, are the closure elements pivoted and made to move in such a way that they virtually form a closed outer wall in front of the respective window or door. Such devices are often used in regions liable to be affected by storms and hurricanes. For example, in the United States devices of this kind are referred to as “hurricane shutters”. However, it is also conceivable to use the device as a single closure for openings in structures, such as for example in the case of winter gardens, terraces or the like. The device then forms the only closure of openings in the structures, it being possible by laterally moving the closure elements together to expose the respective opening in the structure almost completely.

In order that the device described reliably performs its intended function, in particular provides effective protection against storms and hurricanes, not only are neighbouring closure elements connected in a hinge-like manner at their opposite longitudinal edges. Rather, at least some closure elements are also suspended on running carriages, which can be made to move in an upper running rail. In addition, the lower ends of the closure elements are guided in suitable elements. In the case of known devices, because of the hinge-like connection of the closure elements and the guidance of the lower ends of the closure elements, it is relatively difficult to make the running carriages carrying them move. Jamming also often occurs when the closure elements are moved together or apart. That not only hinders operation of the device, it can also lead to damage.

### BRIEF SUMMARY OF THE INVENTION

The invention is based on the object of providing a device for the closure and/or protection of openings in structures which, on the one hand, is adequately stable also to ensure adequate protection and, on the other hand, can be operated easily and unproblematically.

A device for achieving this object is a device for the closure and/or protection of openings in structures, with vertical closure elements in strip form, which are connected to one another in a hinge-like manner and in such a way that they can be turned about vertical longitudinal central axes, and with running carriages, which can be made to move on a horizontal running rail and from which at least some closure elements are suspended, characterized in that the running carriages have a bearing body made of plastic, four running wheels made of plastic, mounted on two parallel axes, and a sliding bearing made of plastic and with good emergency running properties, assigned to each running wheel. Accordingly, the running carriages have a bearing body made of plastic, four running wheels made of plastic, mounted on two parallel axes, and, assigned to each running wheel, a sliding bearing made of plastic with good emergency running properties. It has been found that such running carriages run very smoothly and, as a result, ensure unproblematical movement of the closure elements into an open and closed position of the device.

It is also envisaged to connect the two running wheels, respectively arranged on an axis, by a rotatable bolt. In this case, the running wheels are fastened fixedly, that is to say non-displaceably and non-rotatably, at opposite ends of the respectively rotatable bolt. Each bolt is in turn mounted in the bearing body by two sliding bearings. The two sliding bearings respectively assigned to a bolt lead to the bolt with the two running wheels being exactly guided and easily rotatable. The use of two sliding bearings in the region of each bolt has the effect at the same time that there is a dedicated sliding bearing for each running wheel.

According to a preferred development of the invention, the two sliding bearings assigned to each bolt are assigned to opposite, lateral edge regions of the respective bearing body. In this case, the outer end faces of each sliding bearing are preferably exposed. As a result, these outer end faces form stop faces for the running wheels, whereby axial guidance of the bolts is ensured and the running wheels cannot come into contact with the bearing body, but only with the end faces of the sliding bearings, whereby the stop faces of the sliding bearings have the effect that no appreciable friction occurs when the running wheels come into contact with the stop faces of the sliding bearings with good emergency running properties.

The sliding bearings are preferably arranged more or less completely in appropriately formed, corresponding receptacles of the bearing body. As a result, the sliding bearings are protected in the bearing body, although the arrangement of the sliding bearings in the bearing body of the respective running carriage is made such that the end faces of the sliding bearings with the stop faces for the running wheels protrude slightly from the vertical sides of the bearing body, so that the running wheels can, at most, come into contact with the end faces of the sliding bearings but not with the side faces of the bearing body. Good smooth running of the running carriages, in particular easy rotatability made of the running wheels seated on the bolts, is also ensured as a result of this.

The running carriages are longitudinally movable in a running rail formed in the manner of a box. The running rail has closed side walls and a closed top wall. By contrast, the underside of the running rail is provided with a continuous longitudinal slot, whereby narrow bottom edge strips of the running rail are formed on both sides of the longitudinal slot. On the inner side of the bottom edge strips there are running surfaces for the running wheels of the running carriages to run along. The bearing body of each running carriage is also formed in such a way that it partly extends through the longitudinal slot in the running rail and, as a result, guidance of the running carriage in the direction transversely in relation to the longitudinal rail is formed.

In the case of a preferred configuration of the invention, the lower region of each bearing body that extends through the longitudinal slot of the running rail is assigned at least one guiding roller, which can rotate freely about a vertical axis. The guiding roller is made somewhat narrower than the longitudinal slot, whereby the guiding roller can roll on a side of the longitudinal slot, alternating from side to side. This produces smoothly acting transverse guidance of the running carriage in the respective running rail.

The guiding roller of the bearing body is mounted in a freely rotatable manner on a connecting means extending in a vertically directed and central orientation through the bearing body. The connecting means lies on the central axis of each running carriage and of the closure element assigned to it. The connecting means, which may be a screw, a pin or the like, preferably serves the purpose of respectively connecting a connecting element to the bearing body of the running carriage. As a result, the connecting means has a number of functions. On the one hand, the connecting means serves for the freely rotatable mounting of the guiding roller and, on the other hand, it serves for the suspension of a closure element on the running carriage.

It is also envisaged to provide the two bottom edge strips of the running rails of the running carriages, lying spaced-apart next to one another, with guiding means, in particular longitudinal grooves. The longitudinal grooves in the bottom edge strips of the different bottom edge strips lying next to one another have a spacing which corresponds approximately to the spacing between the vertical central planes of the running wheels. In this way, the running carriages with the running wheels are guided by the guiding means, in particular longitudinal grooves, in the transverse direction of the running rail. This ensures that the guiding rollers come into contact with the sides of the longitudinal slot in the running rail only in exceptional cases. Should this be the case, the longitudinal grooves in the bottom edge strips of the running rail ensure that the running carriages quickly return again to a centrally guided relative position with respect to the running rail. In this way, the guiding means or longitudinal grooves or the like effectively help to allow the running carriages to move smoothly along the running rail.

According to a preferred configuration of the invention, it is provided that the running wheels assigned to the different axes of each running carriage lie as close as possible behind one another. The vertical longitudinal central planes of the running wheels lying one behind the other are preferably in a common vertical plane, which runs centrally through the respective guiding groove, in particular longitudinal groove, in the respective bottom edge strip of the running rail. As a result, the running carriages formed in this way are as short as possible, which ensures that the closure elements run closely together when the device is opened, whereby the inner wall of the opening is exposed to the greatest extent when the device is fully opened.

It is also provided that the diameter of the running wheels of equal size corresponds approximately to the spacing between the parallel axes of the running wheels. This dimensioning and arrangement ensures that the running carriages can run smoothly and that they are good at running straight along the running rail.

It is also provided that the diameter of the running wheels or the spacing between the parallel axes is less than the spacing between the longitudinal central planes of the running wheels at opposite ends of the respective axis. Preferably, the diameter of the running wheels or the spacing between the parallel axes is only 0.7 to 0.9 times the spacing between the running wheels, in particular their vertical longitudinal central planes, at opposite ends of each axis. Good straight running of the running carriages in the running rail is also ensured as a result of this.

According to a preferred configuration of the invention, the sliding bearings are formed from a thermoplastic material with graphite bonded and/or embedded in it. The use of such a plastic provides the sliding bearings with good emergency running properties. The bearing body is preferably formed from a high-strength, tough thermoplastic material. This may be polyamide. The running wheels are preferably formed from a thermoplastic material which is wear-resistant and produces little running noise. This may be a modified polypropylene. The materials mentioned contribute to the long-term functional reliability of the device as a result of exact, smooth running of the running carriages.

### BRIEF DESCRIPTION OF THE DRAWINGS

A preferred exemplary embodiment of the device according to the invention is explained in more detail below on the basis of the drawing, in which:

FIG. 1 shows a plan view of part of the device in a closed position.

FIG. 2 shows a plan view of part of the device in an open position.

FIG. 3 shows a partial side view of the device of FIG. 1.

FIG. 4 shows a partial side view of the device of FIG. 2.

FIG. 5 shows an enlarged cross section V-V through the device of FIG. 3.

FIG. 6 shows a perspective exploded representation of a running carriage of the device.

FIG. 7 shows a plan view of the running carriage of FIG. 6.

FIG. 8 shows a cross section VIII-VIII through the running carriage of FIG. 7.

FIG. 9 shows a partial side view of the running carriage of FIG. 7 in section.

FIG. 10 shows a perspective view of an alternative running carriage.

FIG. 11 shows a plan view of a part of the device with a running carriage pursuant to FIG. 9.

FIG. 12 shows a plan view of a further alternative embodiment of a device pursuant to FIG. 11.

FIG. 13 shows a vertical section through an alternative running carriage analogous to the representation in FIG. 8.

### DETAILED DESCRIPTION OF THE PREFERRED EMBODIMENTS

The device shown here serves for the protection of openings in structures. The device is arranged from the outside in front of a window or a door. The opening in the structure and the window or door are not represented in the figures.

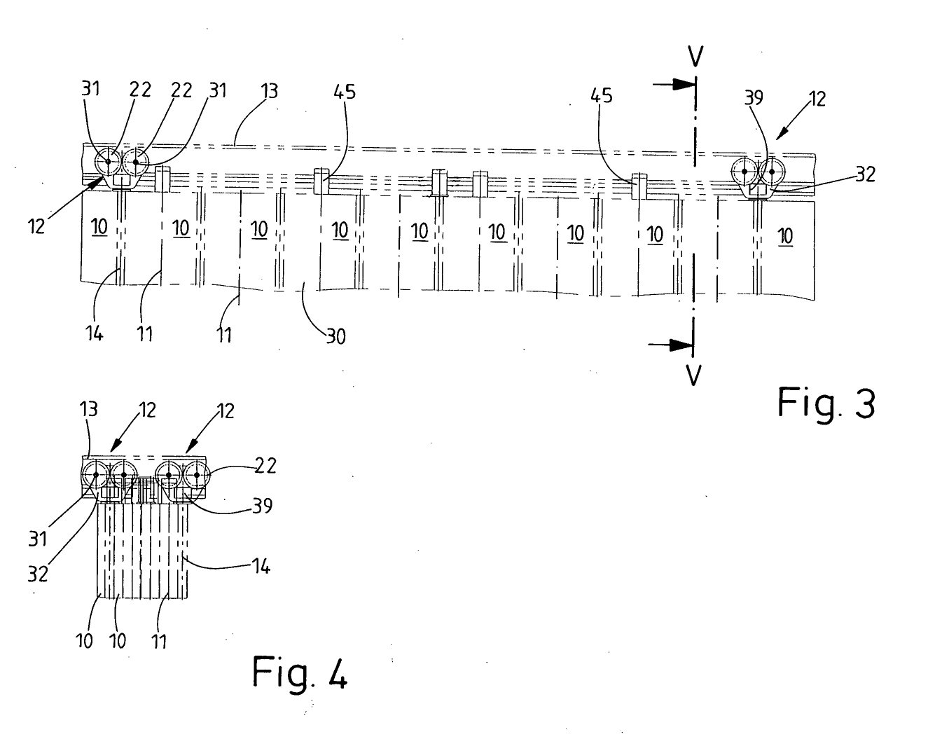

The device shown here is technically referred to as a hurricane shutter. In the closed position (FIGS. 1 and 3), the device virtually forms an essentially completely closed protective wall in or in front of the opening in the wall. Preferably, the device serving as a kind of protective wall is arranged in front of a window or a door for the additional protection of the window or door against being forced in by strong winds, in particular storms and hurricanes. However, the device may also be arranged in front of a door opening or doorless opening in a structure.

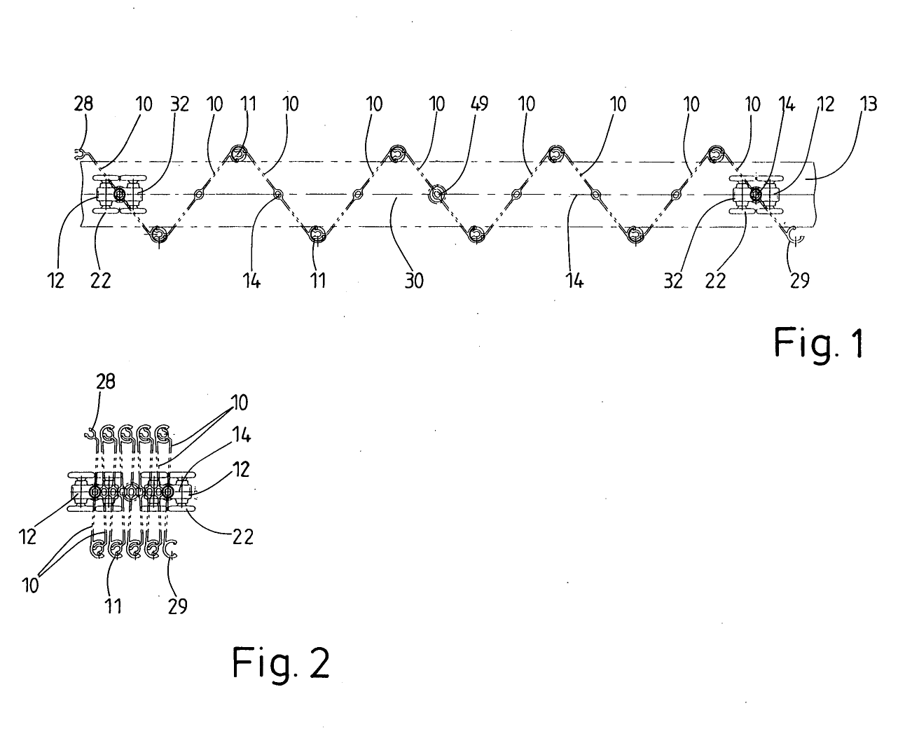

The device has a number of closure elements 10 of an elongated or strip form. Preferably, all the closure elements 10 are formed identically, in particular are of the same size. The elongated closure elements 10 are arranged such that they are vertically directed with respect to their longitudinal direction, that is to say hanging. The individual closure elements 10 are connected in a jointed, preferably hinge-like, manner at the neighbouring longitudinal edges. As a result, vertical hinge axes 11 are formed between neighbouring closure elements. These hinge axes 11 allow the closure elements 10 to be moved together and apart in the manner of an accordion, to be precise from a closed position, which is shown FIGS. 1 and 3, into an open position according to FIGS. 2 and 4, and vice versa.

Some closure elements 10 are suspended at the upper side on identically formed running carriages 12. The running carriages 12 can be made to move longitudinally in an elongated running rail 13. The running rail 13 extends at the upper edge of the opening in the structure over preferably the entire width of the same or even beyond. The running rail 13 is located above a vertical plane 30, which can be closed by the device, vertical longitudinal central axes 14 of each closure element 10 all lying in this vertical plane 30, both in the closed position and in the open position of the device. On the underside, the closure elements 10 are guided in a guiding rail 15, which extends parallel underneath the running rail 13, the guiding rail 15 defining the lower end of the vertical plane 30 (closure plane), through which the longitudinal central axes 14 of all the closure elements 10 run.

The horizontally running, elongated running rail 13 is formed in the manner of a box. For this purpose, the running rail 13 has two parallel, upright side walls 16 and an upper top wall 17. The bottom wall of the running rail 13 is divided to form two bottom edge strips 18. Between the edges 19, directed towards one another, of the bottom edge strips 18 there is a longitudinal slot 20, which runs continuously in the longitudinal direction of the running rail 13. The longitudinal slot 20 is located centrally between the bottom edge strips 18, whereby the center of the longitudinal slot 20 is located on the vertical plane 30 through which the vertical longitudinal central axes 14 of the closure elements 10 run. The two bottom edge strips 18, identically formed and of the same width, form on the inner side of the running rail 13 running surfaces 21 for running wheels 22 of the running carriages 12. The formation described has the effect that, apart from the longitudinal slot 20, the running rail 13 is completely enclosed. The bottom edge strips 18 protrude outwards slightly from each side wall 16 to form vertical outer stop faces 23.

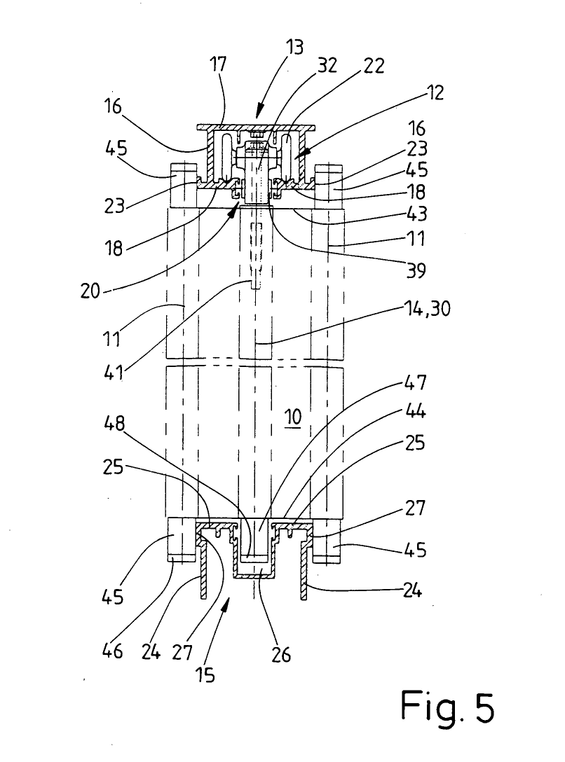

The lower guiding rail 15 is formed in an approximately U-shaped manner in cross section. Arranged between two parallel upright side guiding walls 24 is an upper horizontally running web wall 25, which runs just underneath the closure elements 10. Arranged centrally in the web wall 25 is a cross-sectionally U-shaped depression 26. The center of the depression 26 lies in turn in the vertical plane 30, in which the longitudinal central axes 14 of all the closure elements 10 are located. The side guiding walls 24 have at the upper edge outwardly protruding guiding surfaces 27 (FIG. 5).

The closure elements 10, formed from plastic, thin metal sheet or else optionally from wood, have jointed claws respectively on opposite vertical longitudinal edges, to be precise an upright longitudinal edge of each closure element 10 has an inner jointed claw 28 and the opposite vertical longitudinal edge of each closure element 10 has a larger outer jointed claw 29. The jointed claws 28 and 29 are formed to correspond to one another in such a way that neighbouring closure elements 10 can be connected to one another by an inner jointed claw 28 and an outer jointed claw 29. The jointed claws 28 and 29 are preferably formed in a latching manner, so that neighbouring closure elements 10 can be latched together by the jointed claws 28 and 29. In this case, the formation of the jointed claws 28 and 29 is made such that, after the closure elements 10 are connected, they are pivotable in relation to one another about the hinge axis 11 running through the jointed claws 28 and 29, whereby, in the closed position of the device, the closure elements 10 can be pulled apart in the manner of an accordion and, in the open position of the device, they lie in close contact with one another, running approximately parallel to one another, whereby the closure elements 10 form a space-saving assembly (FIG. 2). During the moving together and pulling apart of the closure elements 10, they are turned about their vertical longitudinal central axis 14, to be precise in such a way that the closure elements 10 run more or less obliquely in relation to the vertical plane 30 through the longitudinal central axes 14 of all the closure elements 10.

Some of the closure elements 10 are suspended under the running carriages 12. In the exemplary embodiment shown, every ninth closure element 10 is suspended from a running carriage 12 that can be made to move longitudinally in the running rail 13. It is also conceivable to provide more or fewer running carriages 12, so that more or fewer closure elements 10 are suspended from running carriages 12. Finally, each closure element 10 may also be suspended from a running carriage 12.

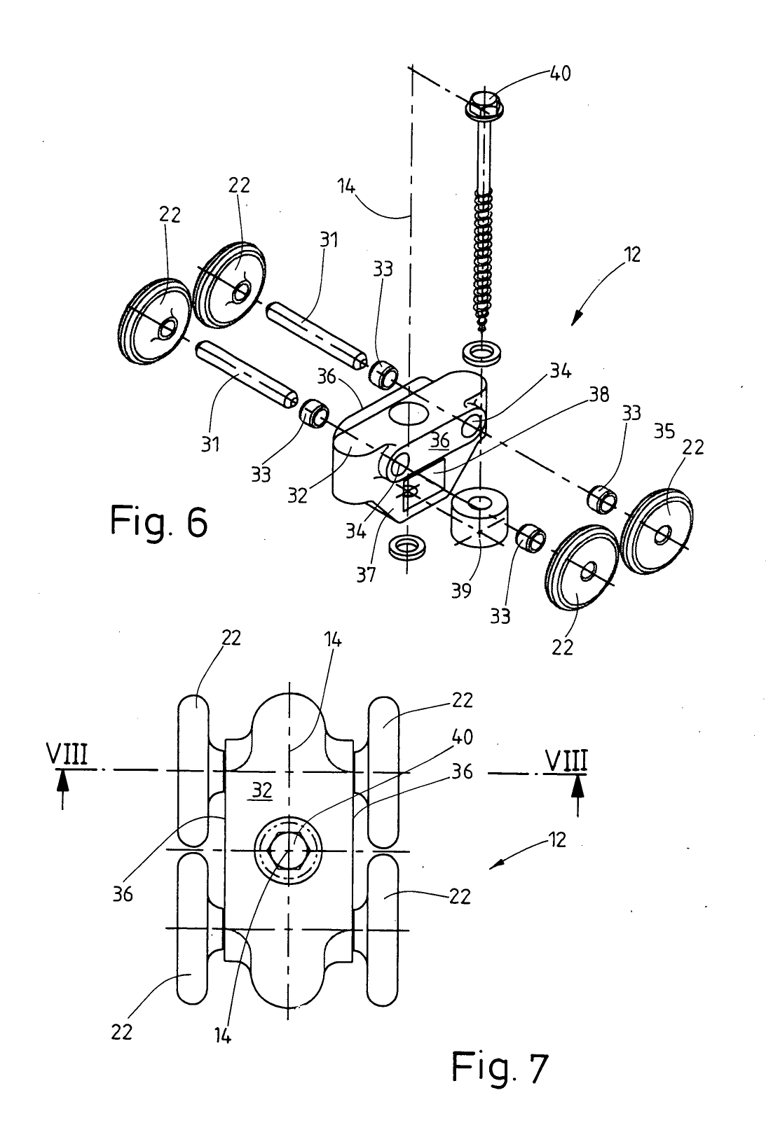

Each of the running carriages 12 that can be made to move in the running rail 13 is formed identically. A running carriage 12 which is described in more detail below is represented in FIGS. 6 to 9.

Each running carriage 12 has four identical running wheels 22. The running wheels 22 are arranged in a tandem manner, whereby each running carriage 12 has two spaced-apart, parallel axes. Each horizontally running axis is assigned two running wheels 22, to be precise at opposite ends of the axis. The running wheels 22 of each axis are connected by a horizontally directed bolt 31. The longitudinal central axis of each bolt 31 forms an axis of the running carriage 12. At opposite ends of each bolt 31, a running wheel 22 is fastened, 25 to be precise fixedly, that is to say both non-rotatably and non-displaceably. Each bolt 31 extends in a horizontally directed orientation transversely in relation to the longitudinal direction of the running rail 13 through a common bearing body 32 of the 30 respective running carriage 12.

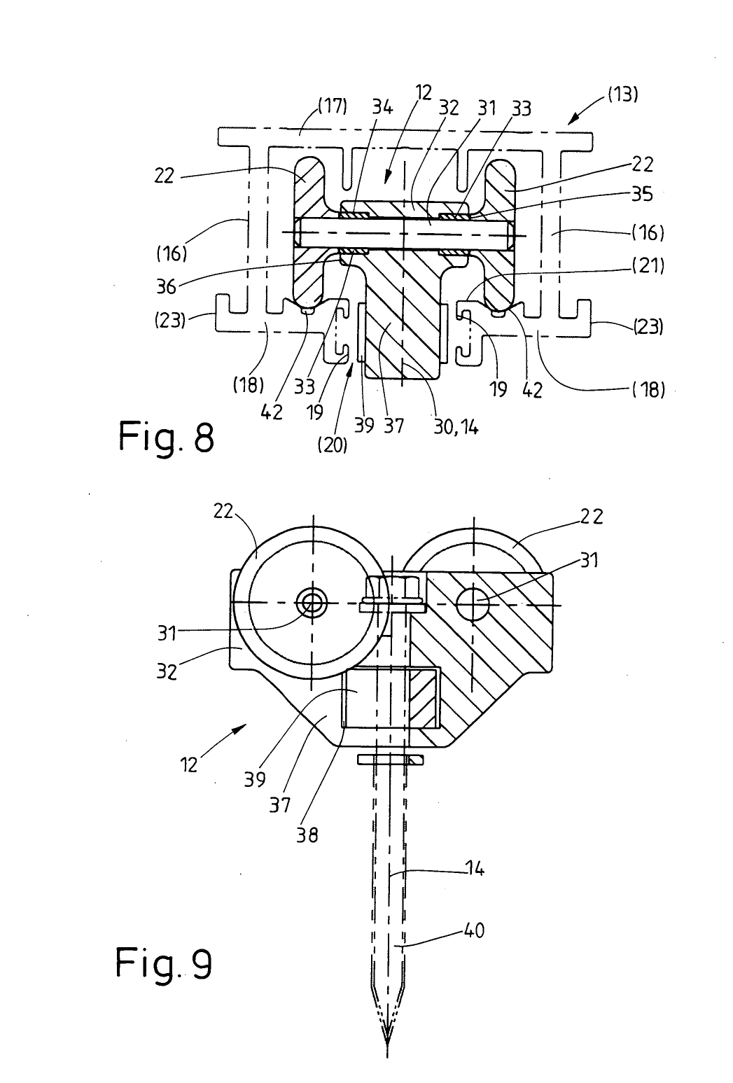

The bolts 31 are mounted in the bearing body 32 by sliding bearings 33. Each bolt 31 is assigned two identical sliding bearings 33. The sliding bearings 33 are formed in the manner of bushes and inserted from opposite sides, from the outside, into blind-hole-like receptacles 34 in bearing body 32. The sliding bearings 33 are held fixedly, in particular non-rotatably and non-displaceably, by corresponding press fits in the receptacles 34. If appropriate, the sliding bearings 33 in the receptacles 34 may be adhesively bonded to the bearing body 32. The receptacles 34 are formed with such a depth that the sliding bearings 33 end with their outer annular end faces 35 approximately flush with the outer sides 36 of the bearing body 32. The end faces 35 of the sliding bearings 33 preferably protrude slightly outwards beyond the sides 36 of the bearing body 32 (FIG. 8). In this way, the end faces 35 of the sliding bearings 33 form stop faces for annular side faces of the hubs of the running wheels 22. The mounting of each bolt 31 on the bearing body 32 by means of two spaced-apart sliding bearings 33 has the effect that each bolt 31 can be rotated easily and with a little play in the sliding bearings 33. The bolts 31 are secured against axial displacement in the bearing body 32 and in the sliding bearings 33 by the fixed arrangement of the running wheels 22 on opposite ends of the bolts 31, the spacing between the running wheels 22 on each bolt 31 being chosen such that a little play is ensured between the end faces 35, serving as stop faces, of the sliding bearings 33 and the sides of the hubs of the running wheels 22 that face towards the end faces 35.

The bearing body 32 has a downwardly protruding region 37, which extends downwards through the longitudinal slot 20 of the running rail 13. The width of this lower region 37 of the bearing body 32 is much less than the width of the longitudinal slot 20 of the running rail 13 and the spacing between the edges 19 fixed thereby for delimiting opposite sides of the longitudinal slot 20 (FIG. 8). Arranged in the lower region 37 of the bearing body 32 is a rectangular aperture 38, running transversely in relation to the longitudinal slot 20. Arranged in this aperture 38 is a guiding roller 39, which can rotate freely about a vertical axis lying on the longitudinal central axis 14. The diameter of the guiding roller 39 is somewhat larger than the width of the lower region 37 of the bearing body 32, whereby the guiding roller 39 protrudes on opposite sides 36 of the region 37. However, the diameter of the guiding roller 39 is in turn somewhat smaller than the width of the longitudinal slot 20 in the running rail 13. As a result, if the running carriage 12 runs off-center in the running rail 13, the guiding roller 39 is supported either on one or the other edge 19 for the lateral delimitation of the longitudinal slot 20. This creates smooth transverse guidance of the running carriage 12 in the running rail 13.

Extending centrally through the bearing body 32 and the guiding roller 39 is a vertical connecting screw 40, which has a self-tapping thread at the lower end. In this case, the connecting screw 40 lies on the longitudinal central axis 14 of the closure element 10 arranged under the running carriage 12. The elongated connecting screw 40 is inserted from above through a central through-bore in the bearing body 32, to be precise also through a central through-bore of the guiding roller 39. In this case, the connecting screw 40 protrudes with its lower threaded portion down from the bearing body 32. With this protruding threaded portion, the connecting screw 40 is screwed from above into a blind bore 41, which lies on the longitudinal central axis 14 of the corresponding closure element 10 and is formed to correspond to the thread of the connecting screw 40. Such a part of the connecting screw 40, which is located in the bearing body 32, in particular in the region of the guiding roller 39, is not provided with a thread, that is to say it is smoothly formed. As a result, the smooth, cylindrical region of the connecting screw 40 can serve for the sliding mounting of the guiding roller 39 in the bearing body 32 (FIG. 9).

The two bottom edge strips 18 of the running rail 13 respectively have a longitudinal groove 42 in the running surface 21 for the running wheels 22. The identically formed longitudinal grooves 42 are formed in an approximately V-shaped manner in cross section (FIG. 8), so that the longitudinal grooves 42 guide the running carriages 12 in a centrally centered manner in the running rail 13. This guidance normally takes place in such a way that, when the running carriage 12 is rolling along in the running rail 13, as far as possible the guiding roller 39 does not come into contact with the vertical edges 19 of the longitudinal slot 20 of the running rail 13. Only if transversely directed forces are exerted on the running carriage 12 with such a magnitude that the longitudinal grooves 42 alone are no longer adequate to keep the running carriage 12 centrally in the running rail 13 is the guiding roller 39 used for additional positive guidance of the running carriage 12 in the longitudinal slot 20 of the running rail 13.

The hinge axes 11 in the region of opposite upright longitudinal edges of the closure elements 10 are extended beyond the upper end 43 and the lower end 44 of the closure elements 10 by stop rollers 45. The cylindrical stop rollers 45 protrude upwards or downwards from the ends 43 and 44 of the closure elements 10. The axes of rotation of the stop rollers 45 lie on the vertical hinge axes 11 or extend them. The stop rollers 45 are mounted in a freely rotatable manner on screws 46, which are screwed from the upper end 43 and from the lower end 44 into the end face of the closure elements 10, to be precise in such a way that the longitudinal axes of the screws 46 lie on the hinge axes 11. The stop rollers 45, rotating freely on the screws 46, are supported on the lateral stop faces 23 of the bottom edge strips 18 of the running rail 13 or the guiding surfaces 27 of the guiding rail 15 when the closure element 10 is in the closed position of the device (FIGS. 1 and 5). As a result, the pulled-apart closure elements 10 in the closed position of the device form a stable wall for the secure closure or secure protection of the opening in a structure, in particular a window or door arranged behind it.

A further guiding roller 47 is arranged protruding from the lower end 44 of at least some closure elements 10. The guiding roller 47 protrudes centrally among several closure elements 10, to be precise in such a way that the central axis of rotation of the respective guiding roller 47 lies on the central longitudinal axis 14 of the closure elements 10 provided with a guiding roller 47. Preferably, a guiding roller 47 is arranged under those closure elements 10 that are suspended from the upper end 43 under a running carriage 12. In addition, a lower guiding roller 47 may be arranged centrally under a closure element 10 lying between two running carriages 12. However, it is also conceivable to assign a lower guiding roller 47 to each closure element 10. Each guiding roller 47 is also freely rotatable about the vertical longitudinal central axis 14, for which purpose the guiding roller 47 concerned is mounted in a freely rotatable manner on a screw 48.

The guiding roller 47 engages in the depression 26 in the lower guiding rail 15, to be precise with a little play. The guiding roller 47 serves the purpose of supporting the closure elements 10 in the guiding rail 15 when the closure elements 10 are pivoted out from the closed position of the device, if the outer guiding rollers 47 are no longer supported on the running rail 13 and the guiding rail 15.

At least one further guiding roller 49 may be arranged between the running carriages 12, protruding from the upper end 43 of the closure elements 10 concerned, so that the guiding roller 49, lying on the longitudinal central axis 14, engages in the longitudinal slot 20 of the running rail 13. It is sufficient if such an upper guiding roller 49 is assigned to a closure element 10 between two running rollers 12. However, it is also conceivable to assign a guiding roller 49 to a number of or to all of the closure elements 10 with the exception of those that are suspended under a running carriage 12.

The guiding rollers 49 also serve the purpose of supporting the closure elements 10 on the running rail 13 if the closure elements 10 are no longer supported by the outer upper stop rollers 45 on the outer stop faces 23 of the running rail 13 when the device is moved out from the closed position.

The running carriages 12 are dimensioned in a special way. The identically formed running wheels 22 have a diameter which is slightly smaller than the spacing between the axes of the bolts 31 carrying the running wheels 22. As a result, the running wheels 22, lying one behind the other, have the smallest possible spacing without touching. Furthermore, the diameter of the running wheels 22 is somewhat smaller than the spacing between the running wheels 22 fastened next to one another on one and the same bolt 31, in particular the spacing between the vertical central planes of the running wheels 22. The diameter of the running wheels 22 is preferably 0.7 to 0.9 times the spacing between the running wheels 22. In the exemplary embodiment shown, the diameter of the running wheels 22 is approximately 0.84 times the spacing between the running wheels 22.

The running carriages 12 are formed from thermoplastic material, apart from the bolts 31 and the connecting screw 40. The sliding bearings 33 consist of a thermoplastic material having good emergency running properties, to be precise preferably an epoxy resin with graphite. The bearing body 32 of the running carriage 12 is formed from a tough and high-strength polyamide. The running wheels 22 consist of a thermoplastic material which has low wear and little running noise. This may be polypropylene, preferably PPTP.

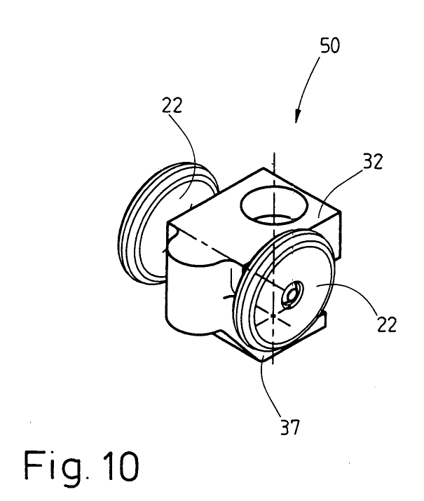

A further running carriage 50 is shown in FIG. 10. It represents a “halved” running carriage 12. The running carriage 50 has only one pair of running wheels 22. Otherwise, the running carriage 50 is configured like the running carriage described above. The same elements are designated with the same reference numbers. In principle, two composite running carriages 50 correspond to a running carriage 12, but with each running carriage 50 having a through bore for the connecting screw 40.

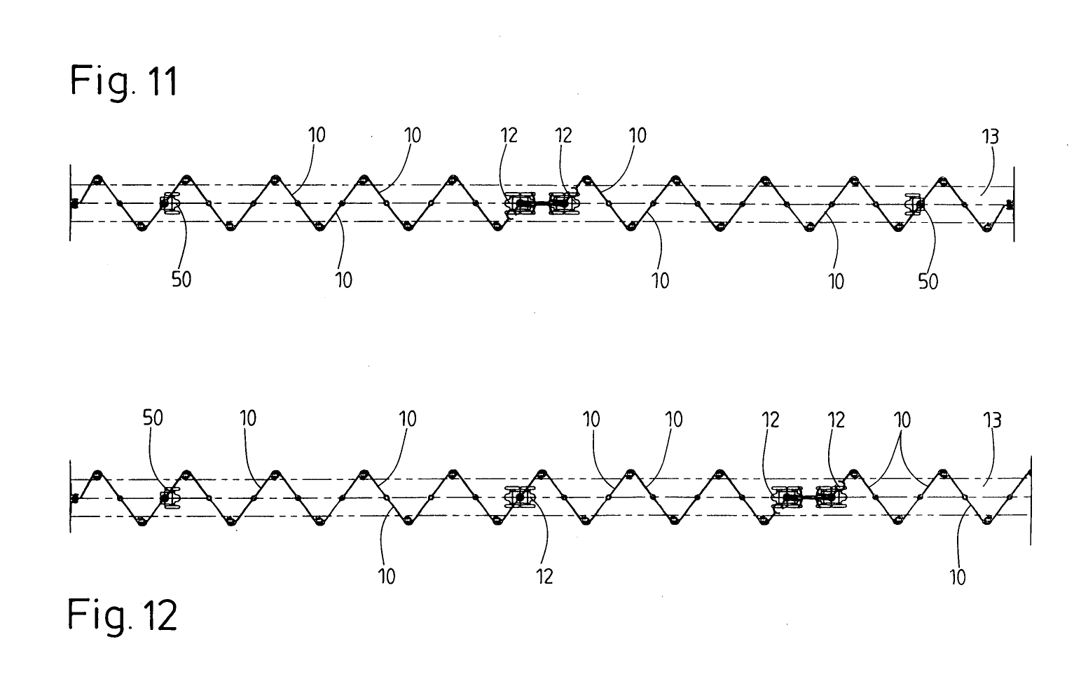

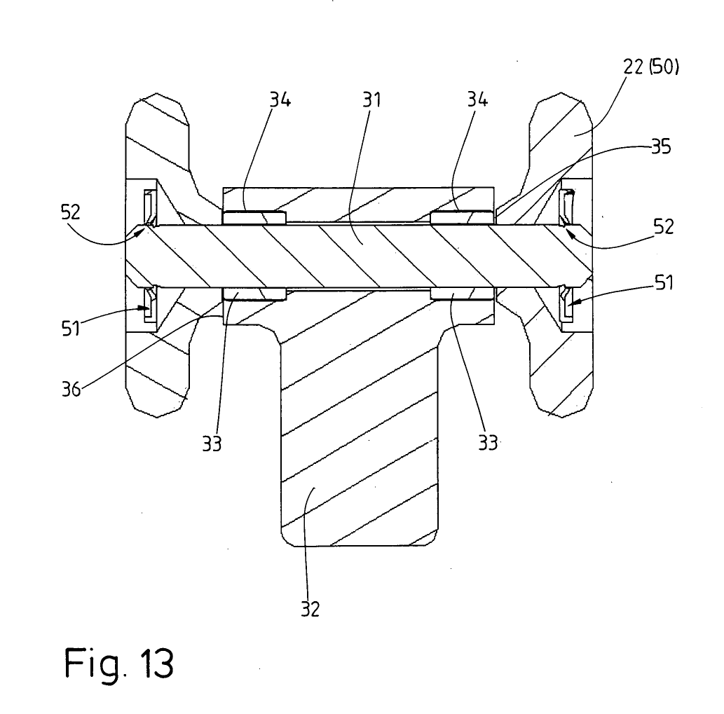

As shown in FIGS. 11 and 12, the shorter running carriages 50 are employed in the lateral edge regions of the device. The decreased length of the running carriages 50 considerably facilitates the assembly of the device. In addition, the shorter running carriage 50 takes up less space than the running carriage 12. In the shown exemplary embodiment pursuant to FIGS. 11 and 12, the running carriages 50 are attached to the third module of closure elements 10 located from each lateral edge.

The bearing of the running wheels 22 on the bolt 31 as shown in FIG. 8 can be configured in the following alternative manner: It is conceivable to provide a snap ring 51 for fixing the respective running wheel 22 and to position it on the bolt 31. Furthermore, it is conceivable to provide the bolts 31 with a circumferential groove-like indentation 52 for the purpose of retaining the sanp rings 51 on the bolt 31. For securing the running wheels 22 by means of the sanp rings 51, the running wheels have a molded recess 54 whose outer dimensions correspond approximately to those of the snap ring 51.

One advantage offered by the snap rings 51 is that the running wheels 22 are secured from any slippage of the bolt 31. It has been demonstrated that this arrangement is particularly effective for combating fluctuating thermal loads and other negative environmental influences.

An important advantage of the previously described solutions can be seen in that, due to the construction of the closure elements 10, travel is also possible along curved running rails whose running rail radius either remains constant of varies. In addition, the constructive design can be effectively employed in warmer areas or areas contaminated by brine, such as in tropical regions, because the selected materials reduce the susceptibility to corrosion to a minimum. The material selected for the running wheels 22 is also characterized by its high load bearing capacity with little accompanying wear.

### List of Reference Numerals

10 closure element
11 hinge axis
12 running carriage
13 running rail
14 longitudinal central axis
15 guiding rail
16 side wall
17 top wall
18 bottom edge strip
19 edge
20 longitudinal slot
21 running surface
22 running wheel
23 stop face
24 side guiding wall
25 web wall
26 depression
27 guiding surface
28 inner jointed claw
29 outer jointed claw
30 vertical plane
31 bolt
32 bearing body
33 sliding bearing
34 receptacle
35 end face
36 side
37 region
38 aperture
39 guiding roller
40 connecting screw
41 blind bore
42 longitudinal groove
43 upper end
44 lower end
45 stop roller
46 screw
47 guiding roller
48 screw
49 guiding roller
50 running carriage
51 snap ring
52 indentation
54 recess

1. Device for the closure and/or protection of openings in structures, with vertical closure elements (10) in strip form, which are connected to one another in a hinge-like manner and in such a way that they can be turned about vertical longitudinal central axes (14), and with running carriages (12), which can be made to move on a horizontal running rail (13) and from which at least some closure elements (10) are suspended, characterized in that the running carriages (12) have a bearing body (32) made of plastic, four running wheels (22) made of plastic, mounted on two parallel axes, and a sliding bearing (33) made of plastic and with good emergency running properties, assigned to each running wheel (22).

2. Device according to claim 1, characterized in that two of the running wheels (22) respectively lying on each one of the axes are connected by a rotatable bolt (31), the running wheels (22) being fixed on the rotatable bolt (31) and each bolt (31) being mounted in the bearing body (32) by two sliding bearings (33).

3. Device according to claim 1, characterized in that the two sliding bearings (33) assigned to each bolt (31) are assigned to opposite lateral edge regions of the respective bearing body (32), preferably in such a way that an outer end face (35) of the respective sliding bearing (33) is exposed to form a stop face for each running wheel (22).

4. Device according to claim 1, characterized in that the sliding bearings (33) are arranged substantially completely in corresponding receptacles (34) of the bearing body (32), non-rotatably and non-displaceably.

5. Device according to claim 1, characterized in that an underside of the running rail (13) formed in the manner of a box has a continuous longitudinal slot (20), narrow bottom edge strips (18) of the running rail (13) being formed on both sides of the longitudinal slot (20), and the bearing body (32) of the respective running carriage (12) being guided in the longitudinal slot (20).

6. Device according to claim 5, characterized in that the lower region of the bearing body (32) of each running carriage (12) that extends through the longitudinal slot (20) of the running rail (13) is assigned at least one guiding roller (39), which can rotate freely about a vertical axis and can be brought into contact, alternating from side to side, with a guiding surface (edge 19) of the running rail (13) delimiting the longitudinal slot (20) on both sides.

7. Device according to claim 6, characterized in that the guiding roller (39) of each running carriage (12) is mounted in a freely rotatable manner on a connecting means extending in a vertically directed and central orientation through the bearing body (32), preferably a connecting screw (40), a closure element (10) to which a running carriage (12) is assigned preferably being respectively fastened to the running carriage (12) by the connecting means.

8. Device according to claim 5, characterized in that the two bottom edge strips (18) of the running rail (13) are respectively provided with at least one guiding means in a running surface (21) for the running wheels (22), the respective guiding means preferably being formed as a longitudinal groove (42).

9. Device according to claim 8, characterized in that the running wheels (22) assigned to the different axes of each running carriage (12) lie as close as possible behind one another, preferably in such a way that longitudinal central planes of the running wheels (22) lying one behind the other lie in a common, vertical plane, which runs centrally through the respective guiding means, in particular the longitudinal groove (42), in each running surface (21) of the bottom edge strip (18).

10. Device according to claim 1, characterized in that the diameter of the running wheels (22) of equal size is slightly smaller the spacing between the parallel axes of the running wheels (22).

11. Device according to claim 1, characterized in that the diameter of the running wheels (22) or the spacing between the parallel axes on which the running wheels (22) are arranged is smaller than the spacing between the vertical longitudinal central planes of the running wheels (22) on opposite ends of the respective axis, the axial spacing between the opposite running wheels (22) preferably being 0.7 to 0.9 times the diameter of the running wheels (22) or the spacing between the parallel axes.

12. Device according to claim 1, characterized in that the sliding bearings (33) are formed from a thermoplastic material with a graphite.

13. Device according to claim 1, characterized in that the bearing bodies (32) are formed from high-strength, tough thermoplastic material.

14. Device according to claim 1, characterized in that the running wheels (22) are formed from a thermoplastic material which is wear-resistant and causes little running noise.

15. Device according to claim 13, characterized in that the thermoplastic material for the bearing bodies (32) is polyamide.

16. Device according to claim 14, characterized in that the thermoplastic material for the running wheels (22) is polypropylene.
